(19) United States
(12) Patent Application Publication
(10) Pub. No.: US 2010/0270410 A1
(43) Pub. Date: Oct. 28, 2010

(54) Material Shredder including reverse-facing, pass-by-interlocking, rotor-cutter/bed-knife cutting edges

(75) Inventor: Todd A. Sears, Oregon City, OR (US)

Correspondence Address: ROBERT D. VARITZ, P.C., 4915 SE 33RD PLACE, PORTLAND, OR, 97202, US

(73) Assignee: SSI Shredding Sytems, Inc.

(21) Appl. No.: 12/799,559

(22) Filed: Apr. 26, 2010

Related U.S. Application Data
(60) Provisional application No. 61/214,748, filed on Apr. 27, 2009.

(51) Int. Cl. B02C 18/18

(52) U.S. Cl. 241/220

(57) ABSTRACT

A material shredder including an elongate rotor including distributed, outwardly projecting cutting teeth having cutting edges collectively defining a rotor cutting profile, and an elongate bed-knife disposed operatively adjacent the rotor and possessing distributed cutting edges collectively defining a bed-knife cutting profile which meshes complementarily with the rotor cutting profile with rotation of the rotor, these two profiles collectively defining an elongate shredding interface wherein there are certain reverse-facing, mutually facing, respective cutting edges in the teeth and bed-knife that face, respectively, toward and away from the rotor.

### CROSS-REFERENCE TO RELATED APPLICATION

This application claims filing-date priority to currently copending, U.S. Provisional Patent Application Ser. No. 61/214,748, filed Apr. 27, 2009, for “Shredder With Clearance-Interface Cutter Teeth and Bed-knife”. The entire disclosure content of this provisional application is hereby incorporated herein by reference.

### BACKGROUND AND SUMMARY OF THE INVENTION

This invention relates generally to a material shredder defined by a special, continuous shredding interface, and more particularly, to the configuration of such an interface, or cutting profile, which forms a defining characteristic of such a shredder. Even more especially, the present invention relates to a material shredder interface (which may be thought of as being the shredder, per se) having what are referred to herein as reverse-facing, pass-by-interlocking, rotor-cutter/bed-knife cutting edges, as well as pairs of cutting edges in each of the cutting teeth carried by a rotor, and in fingers, or projections, formed in a bed-knife, which directly face and substantially parallel one another.

The rotor referred to herein carries such teeth, which are also referred to as cutters, as rotor-cutters, as cutting teeth, and simply as teeth. The rotor which carries these teeth is also referred to as a rotary cutter. The term “bed-knife” is used interchangeably with the term “anvil”. Cutting edges relevant to defining the shredding/cutting interface of the invention are straight-linear in nature, and are formed both in the teeth and in the bed-knife.

A material shredder of the type involved here is a power tool, often a massive power tool, which is used in a wide variety of settings today to comminute different materials so as to create small particles thereof which may be recycled for future use. Specific materials shredded may include, for examples, paper, metal, plastic, glass, etc.

In such a shredder, it is typical that a rotary cutter, driven under power on an appropriate rotational axis, carries on its periphery a lateral distribution of cutting teeth having cutting edges that collectively define a one side of a cutting, or shredding, profile which is effectively complementarily matched by a similar, opposite-side, cutting profile furnished by the cutting edges formed in a stationary anvil. The anvil cutting edges, together with those in the teeth, define an elongate shredding, or cutting, interface through which properly shredded material is intended to pass and be carried away from the shredding machine.

A problem exists in a number of instances with such machines. This problem is that, in reality, lateral (essentially along what may be thought of as the cutting axis of a cutting interface) “non-cutting, non-shredding” spaces exist between “operationally”, longitudinally-laterally/axially, next-adjacent cutting teeth, as such teeth are actually deployed on the periphery of a rotary cutter. “Operationally” next-adjacent teeth are those, as referred to herein, which define the next-adjacent cutting, or shredding swaths (paths), distributed along the cutting interface. These spaces, where shredding, or cutting, swaths do not overlap, define troublesome clearance spaces in association with the cooperative anvil. In particular, these spaces allowing not fully shredded, and often relatively large, pieces of intended-to-be-shredded material to pass through the shredding interface and to become, unless otherwise isolated (at additional cost, effort, and machine complexity), improperly co-mingled with properly shredded material.

One attempted resolution to this problem involves the employment of an appropriate collection-zone screen disposed below where shredding takes place, with this screen having openings that provide a “mesh size” through which properly shredded-size material may pass, but through which enlarged material pieces which have not been properly shredded may not pass. The collection zone thus defined by such a screen itself presents certain problems, not the least of which involves blocking (blinding) the screen with shredded material too large to pass through the screen, greatly reducing machine processing throughput efficiency and creating excessive heat while shredding combustible materials. Such a collection zone also introduces elevated machine material and manufacturing costs, and dictates a time-consuming and expensive, unwanted-material-removal activity.

There are other prior-art solution approaches which also have not been entirely satisfactory, including various different kinds of shredding-interface geometries.

In this setting, I have discovered a practical and very satisfactory resolution to the stated problem in the form of a unique shredding interface and cutting profile/configuration having a special cutting-tooth/bed-knife meshing configuration, or geometry. This configuration, which I refer to, inter alia, as one characterized by reverse-facing, pass-by-interlocking, rotor-cutter/bed-knife cutting edges, is characterized additionally by a kind of crenellation form of intermeshing rotor-cutter teeth, and stationary-anvil cutting projections, angulated in a special way, with these teeth and projections extending complementarily into inter-projection, and inter-teeth, channel spaces, respectively.

The geometry of the cutting profile, or shredding interface, of the present invention features an elongate, angular, geometrically repetitive, line-segment pattern lying between the angular cutting edges of the cutting teeth carried by the rotor, and the angular cutting edge formed in the anvil/bed-knife—preferably a unitary structure—along which pattern cutting/shredding takes place during operation of the shredder with rotation of the rotor relative to the anvil. This pattern generally lies along what might be thought of as an elongate cutting axis which substantially parallels the rotational axis of the rotor. It is a pattern which, rather than physically existing all at one time along its length, is “formed as a whole” recurrently over a finite period of time during successive portions of each cycle of rotation of the rotor as different cutting teeth, at different locations along the length of the rotor, and at specifically different times, intermesh with and sweep in rotation closely past the anvil. For certain practical discussion purposes herein, the cutting interface of the invention will be treated as being a whole all of the time.

The above-mentioned pass-by-interlocking concept describes an important and unique structural feature of the interface of the invention, which feature results from the presence in that interface of what I have referred to above as reverse-facing cutting edges. The term “reverse-facing cutting edges” refers to the fact that there are cutting edges in the rotor-carried teeth which effectively face the rotor rather than the anvil, and cutting edges in the anvil which face the anvil rather than the rotor. Conventionally in a shredder in the category disclosed herein, cutting edges in rotor teeth all face the anvil, and cutting edges in the anvil all face the rotor.

According to the incorporated, pass-by-interlocking feature, created by the reverse-facing cutting edges, pass-by interlocking occurs/exists under all circumstances with a tooth meshed with an associated portion of the anvil. With such interlocking in place, and it always is in the preferred and best mode embodiment of the invention since there is always at least one tooth meshed with the anvil, it is not possible, in a certain range of planes of relative translational motion, to create a parting, or separation, between the rotor and the anvil. And, while such a separation, or parting, is not a function involved especially with a shredding operation, this “anti-separation” thought characterizes the “reverse-facing cutting edges”, “interlock” condition which prevents separation, and helps to express an offering of the invention which has been found to play a key role in the highly satisfactory shredding performance of a shredder employing the invention.

Accordingly, and in relation to one way of expressing the material shredder of the present invention, in its preferred and best mode form, it includes (a) an elongate rotor including distributed, outwardly projecting cutting teeth having cutting edges collectively defining a rotor cutting profile, (b) an elongate bed-knife disposed operatively adjacent the rotor and possessing distributed cutting edges collectively defining a bed-knife cutting profile which meshes complementarily with the rotor cutting profile with rotation of the rotor, and (c), these profiles collectively defining an elongate shredding interface which is characterized, at least in part, by reverse-facing, pass-by-interlocking, rotor-teeth/bed-knife cutting edges.

In another way of describing the invented material shredder, it includes (a) an elongate rotor carrying distributed, outwardly projecting cutting teeth having cutting edges collectively defining a rotor cutting profile, (b) an elongate bed-knife disposed operatively adjacent the rotor and possessing distributed cutting edges collectively defining a bed-knife cutting profile which meshes complementarily with the rotor cutting profile with rotation of the rotor, and (c), these profiles collectively defining an elongate shredding interface wherein there are certain reverse-facing, mutually facing, respective cutting edges in the teeth and bed-knife that face, respectively, toward and away from the rotor.

In still a further way of describing the material shredder of the present invention, it includes (1) an elongate rotor having a generally cylindrical outer-surfaced body which is rotatable about a rotor axis, (2) a distribution of plural, common-configuration cutting teeth joined to the rotor body and having cutting edges projecting generally radially outwardly from immediately adjacent that body's outer surface to define, with rotation of the rotor, one side of an elongate, continuous, two-sided shredding interface which generally parallels the mentioned axis, and (3), an elongate bed-knife disposed operatively adjacent and along the rotor in a manner substantially paralleling the rotor axis and defining the other side of the shredding interface, this bed-knife including distributed cutting-edge portions which extend essentially to the outer surface of the rotor body.

Yet another manner of describing the invented shredder is to recognize it as featuring (a) an elongate rotor including distributed, outwardly projecting cutting teeth having cutting edges collectively defining a rotor cutting profile, and each including a pair of such edges which substantially directly face one another, (b) an elongate bed-knife disposed operatively adjacent the rotor and possessing distributed cutting edges collectively defining a bed-knife cutting profile which meshes complementarily with the rotor cutting profile with rotation of the rotor, and with the cutting edges in the bed-knife also including a pair of edges which substantially directly face one another, with (c) these two profiles collectively defining an elongate shredding interface which is characterized, at least in part, by reverse-facing, pass-by-interlocking, rotor-teeth/bed-knife cutting edges that include at least one each of the substantially directly-facing edges in the teeth and bed-knife.

One further way of visualizing the invention, and an important feature in the incorporated shredding interface, is to see it as a material shredder including an elongate rotor having a rotor axis, and which carries outwardly projecting cutting teeth having cutting-edges collectively defining a rotor cutting profile, and an elongate bed-knife disposed operatively adjacent the rotor, and possessing distributed cutting edges and cutting surfaces collectively defining a bed-knife cutting profile which meshes complementarily with the rotor cutting profile with rotation of the rotor, these bed-knife cutting surfaces taking the form of surfaces of revolution substantially centered on the rotor axis.

These features of the invention, and their performance, operational and cost advantages, will become more fully apparent as the detailed description of the invention which follows below, is read in conjunction with the accompanying drawings.

### DESCRIPTIONS OF THE DRAWINGS

FIG. 1 is a simplified, fragmentary, schematic, lateral elevation showing the cutter-carrying rotor and the associated anvil, or bed-knife, in a material shredder which incorporates the preferred, and best mode, embodiment of the cutting profile, or shredding interface, of the present invention. The term “cutting profile”, which means the same thing as “the shredding interface”, will be defined shortly herein.

FIG. 2 is a simplified, fragmentary, schematic, downwardly and laterally looking view of the shredder of FIG. 1, drawn on about the same scale as that which is used in FIG. 1, further illustrating features of the shredding interface of the invention.

FIG. 3, which has been drawn on a larger scale than that employed in FIGS. 1 and 2, shows: in View (a) a fragmentary, developed illustration of the interactive and cooperative cutting, or shredding, interaction, and interface existing operatively, between a pair of “laterally/axially next-adjacent” cutting teeth, or cutters, carried on the rotor pictured in FIGS. 1 and 2, and the associated anvil which is also pictured in these two figures; in View (b) a “surface profile characteristic” of the rotor; and in the View (c), in dashed lines, an isolated fragment of the shredding interface, per se. The terms “laterally/axially next-adjacent” and “surface profile characteristic” will be defined later herein.

FIG. 4 is a fragmentary, cross-sectional view taken generally along the line 4-4 in FIG. 3. This figure illustrates in detail what are referred to herein as reverse facing cutting edges, and curved cutting surfaces in the bed-knife and in the cutting teeth in the shredding interface.

FIG. 5, in Views (a), (b) and (c) is like FIG. 3, except that it illustrates a modified form of shredding interface made in accordance with the invention.

Components illustrated in the drawings are not necessarily drawn to scale.

### DEFINITIONS

The term “laterally/axially next-adjacent”, in relation to the cutting teeth, refers to pairs of cutting teeth that are distributed longitudinally on, i.e., along the length of, the rotor which perform laterally next-adjacent, laterally overlapping, cutting (or shredding) swaths relative to a bed-knife during operation of the shredder. In order for such overlapping to occur—an occurrence which is important for proper shredding—two such teeth cannot simultaneously sweep past the anvil, and thus must be circumferentially displaced, or angularly offset, on the surface of the rotor, while at the same time occupying laterally next-adjacent positions, or paths, of rotational travel on the surface of the rotor. More will be said about this disposition of rotor-carried cutting teeth later herein.

The term “surface profile characteristic” as applied to the rotor, refers herein to the apparent surface landscape of the main body of the rotor as “perceived” by certain projecting cutting fingers that are formed in the anvil. Two embodiments of the invention are illustrated and described herein, and in each of these to embodiments, these fingers “perceive” different rotor-surface landscapes, in a manner of thinking. In one, the fingers perceive a landscape which is generally cylindrical, but interrupted in regular, longitudinally spaced and distributed locations along the rotor, by cross-sectionally angular “V” grooves extending radially into the rotor main body. In the other, the fingers “perceive” a rotor landscape which is, effectively, pure cylindrical.

### DETAILED DESCRIPTION OF THE INVENTION

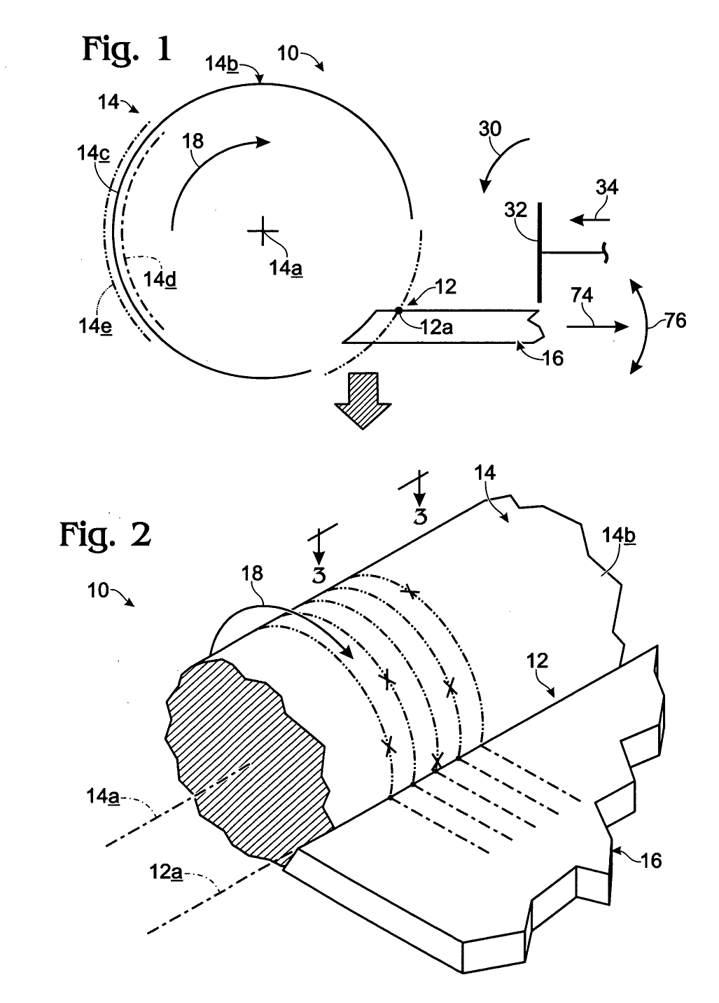

Turning now to the drawings, and referring first of all to FIGS. 1 and 2, indicated very schematically, and fragmentarily, at 10 is a power-operated, material shredder for shredding materials like those mentioned above. Shredder 10 includes an elongate, continuous, two-sided, shredding, or cutting, interface 12 that exists, effectively, between a power-driven, generally cylindrical outside-surface rotor 14, having a rotational, or rotor, axis 14a, and an elongate, generally linear, stationary, tool-steel bed-knife, or anvil, 16 which is disposed appropriately operatively adjacent the rotor. As will become more apparent shortly, interface 12 takes the form of a special, angular, line-segment pattern of rotor-teeth and bed-knife linear cutting edges distributed along an elongate cutting axis 12a which generally parallels rotor axis 14a.

As a practical matter with respect to the focus of the present invention, the shredder and its shredding interface are treatable as being one and the same, and are so treated in discussions about the invention herein.

Those skilled in the art will recognize that rotor 14 and bed-knife 16 are suitably mounted on a supporting frame (not shown), with the rotor appropriately journaled for power-driven rotation on and about axis 14a. While different structural, dimensional, and operational specifications are freely and understandably selectable by those skilled in the art who choose to practice the present invention, in the shredder which is now being described, and which is illustrated herein, rotor 14 has a nominal, outside-surface cylindrical diameter herein of about 20-inches, this diameter defining a nominal rotor-body 14b circumference which is shown by a solid, circular line 14c in FIG. 1, a nominal length of about 67-inches, and is driven under power at a rotational speed of about 92-RPM by an appropriately drivingly, connected 200-horsepower motor. The direction of power-driven rotor rotation is indicated by curved arrow 18 pictured in FIGS. 1 and 2.

The preferred and best mode embodiment of the shredder of the invention, made in accordance with the herein-presented (above and below), illustrative dimensions and configurations, is designed to be capable of 100% appropriate-size shredding of plastic material at a throughput rate of about 10,000-lbs-per-hour.

As is sometimes the case with conventional rotary-cutter shredders, the rotors that are employed therein are formed in a segmented fashion, which takes the form of an appropriate assembly of substantially hockey-puck-shaped, cylindrical segments anchored to one another to form a unitary rotor body. This same kind of segmented, rotor-body structure characterizes body 14b in rotor 14. The individual segments that make up body 14b are not specifically illustrated herein.

Rotor 14 is referred to herein as having a generally, or nominally, cylindrical, outer-surfaced body to reflect the fact that the specific surface configuration of the outside surface of the rotor takes two, slightly different forms in relation to the earlier-mentioned, two embodiments of the invention which are illustrated and described herein. In one of these forms, what may be thought of as the circumferential tracks, or paths, (still to be more fully described) that are followed by the rotor-carried cutter teeth with rotation of the rotor are characterized with radially inwardly extending, or inset, circumferential V-grooves, or channels (shortly to be discussed) which are distributed in evenly spaced, lateral (i.e., rotor-long-axis) relationship along the length of the rotor body. In the other, rotor outside-surface form, the outside surface configuration of the rotor is substantially pure cylindrical, i.e., without the presence of such circumferential channels.

FIGS. 1-3, inclusive, in the drawings illustrate the first-mentioned form of the invention characterized with a circumferentially channeled outer-surface rotor. As will be explained more fully shortly, in this circumferentially channeled form of the rotor, elongate projections, or fingers (alternatively called finger portions), which fingers will also shortly be more fully described, extend from bed-knife 16 into these channels in the rotor in order to place bed-knife cutting edges close to the effective outside surface topography (within the V-grooves) of the rotor. It is for this reason that, especially in FIG. 1, the left end of fragmentarily shown bed-knife 16 is pictured extending into the circle enclosed by solid circular line 14c which, as was mentioned above, represents the circumferential outline of the nominal, cylindrical, outside-surface portion of rotor body 14b.

In FIG. 1, in addition to the presence there of previously discussed, solid, circular line 14c, two other circular lines of different diameters, both centered on axis 14a are shown. These two lines, designated 14d, 14e, represent respectively (a) the common diameter of the bases of the mentioned, radially inwardly extending, distributed, circumferential channels (the V-grooves) that are formed in rotor body 14b, and (b) the common radially-outer extent of the circular paths which are followed by the outer extremities of the commonly configured, radially outwardly projecting cutting teeth (still to be described) that are carried on, and that extend outwardly from the outside of, the rotor body.

Turning attention for a moment specifically to FIG. 2, and again recognizing that those who choose to practice the present invention may use different structural specifications depending upon the shredding applications which they have in mind, rotor 14 herein carries eighty, common-configuration cutting teeth suitably anchored, two-each, in forty, evenly laterally (i.e., longitudinally relative to the rotor) distributed circumferential paths, with each such path effectively including the two, associated cutting teeth deployed 180-degrees apart relative to rotor axis 14a. Several of these circumferential paths, of the total of the forty paths just mentioned, are illustrated by dash-dot lines 20, with several, tool-steel cutting teeth that are associated with these paths—one per path—being indicated by small Xs in FIG. 2.

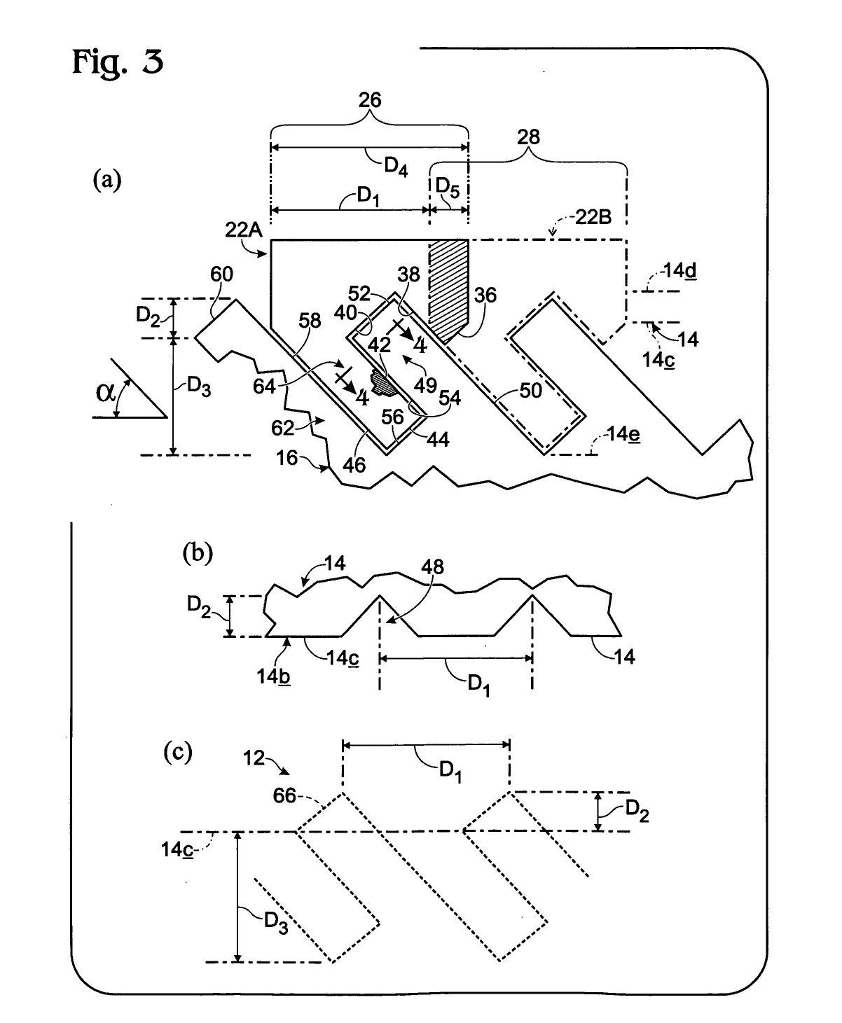

As will be made more fully apparent shortly with respect to the description which shortly follows involving FIG. 3, the cutting teeth are sized, and organized in such a fashion on the rotor in their respective associated circumferential paths, so as to possess a certain amount of lateral (i.e., longitudinal relative to rotor length) overlap. The cutting teeth are also specifically arranged in such a fashion that, effectively, only one tooth is fully meshed at any given point in time with cutting-edge structure, still to be described, in the bed-knife, so that a potentially machine jamming work overload is not experienced during a shredding operation. In a more specific sense, as a particular cutting tooth begins to intermesh with cutting structure in the bed-knife, a precedingly active (in time) cutting tooth is just exiting a bed-knife intermeshing condition. In the particular embodiment of the shredder which is now being described, and given the total number of eighty teeth which are carried by rotor 14, specific teeth which in succession enter a condition of intermeshing with cutting structure in the bed-knife are organized with an angular offset about rotor axis 14a of about 4.5-degrees.

The order in time in which successive teeth enter a condition of intermeshing with the bed-knife is dependent, of course, upon the specific arrangement of these teeth on the surface of the rotor. This order is not necessarily one in which laterally next-adjacent teeth “follow” one another into and through this condition. Those who are skilled in the relevant art will know how to establish an appropriate order of intermeshing.

With respect to the several cutting teeth illustrated schematically by small Xs in FIG. 2, the points, or locations, of intermeshing with cutting structure furnished in bed-knife 16 are illustrated by small blackened dots 24.

Linking attention for a moment now to certain aspects of FIG. 3 along with what is shown in FIGS. 1 and 2, various illustrative dimensions and dimensional relationships are here mentioned. FIG. 3, in View (a), shows (fictionally) in the single, common plane of this figure, two laterally next adjacent cutting teeth 22A, 22B, and a fragment of bed-knife 16. The term “fictionally” just used has been employed to point out that two such teeth never actually lie in the same plane which also contains rotor axis 14a (not pictured in FIG. 3).

The distance, or lateral/longitudinal separation, D₁ between next-adjacent paths 20, which effectively describes the distance between the center lines of the shredding, or cutting, swaths of next-adjacent cutting teeth herein, as well as the distance between common, structural points on laterally next-adjacent teeth, is about 1.72-inches. The central depth D₂ of the previously mentioned circumferential V-channels (grooves) provided in the outer surface of rotor 14 is about is 0.375-inches, which means that the diameter of the circle in FIG. 1 pictured there by line 14d is about 19.625-inches. Circular line 14d of FIG. 1 is shown schematically in FIG. 3, View (a) as a short, straight, dash-dot line. Circular line 14c in FIG. 1, which line represents the nominal, cylindrical, outer surface of the rotor, is pictured schematically in FIG. 3, View (a) as another, short, straight, dash-dot line.

The outer extremities of cutting teeth 22 extend approximately 1.25-inches (dimension D₃) radially outwardly from the nominal, cylindrical, outer surface of rotor 14, which means that the diameter of the circle pictured in FIG. 1 by line 14e is about 22.5-inches. Circular line 14e in FIG. 1 is pictured schematically as a short, straight, dash-dot line in FIG. 3, View (a).

The manners in which the cutting teeth “present themselves” radially outwardly from the rotor's nominal, cylindrical outer surface, and in consideration of the preferred tooth shapes, per se, as illustrated in FIG. 3, View (a), results in these teeth establishing cutting, or shredding, swaths (see 26, 28 in FIG. 3, View (a) for teeth 22A, 22B, respectively) of about 1.875-inches (dimension D₄), which swaths laterally overlap one another by a dimension D₅ of about 0.155-inches (see the shaded area in FIG. 3, View (a)).

Completing now a description of what is shown in FIG. 1 in shredder 10, a slightly curved, downwardly pointing arrow 30 illustrates the manner in which material which is to be shredded is introduced into an open-topped bin (not specifically shown) disposed above bed-knife 16 in a region which lies between rotor 14 and an hydraulically driven pusher platen 32 which is operated appropriately under power, in the direction of the arrow shown at 34, to drive material to be shredded effectively toward shredding interface 12.

Focusing attention now especially on FIG. 3, as was mentioned above, in this figure, and particularly in View (a) in the figure, two, next-adjacent cutting teeth 22A, 22B are illustrated lying in the plane of this view, along with a fragment of bed-knife 16. These two, mentioned cutting teeth are shown effectively isolated from the rotor body, but are also pictured in such a fashion that the portions of these teeth which project radially outwardly from the nominal, cylindrical outer surface of the rotor are clearly indicated as those portions of the teeth which extend below dash-dot line 14c in this same view. Not illustrated in FIG. 3, or in any other of the drawing figures herein, is the manner in which the cutting teeth are anchored to the segments which make up the body in rotor 14, but it should be understood that this manner of anchoring forms no part of the present invention, is conventional in nature, and may be structured in any one of a number of suitable ways. Preferably, the individual cutting teeth are anchored so as to be replaceable as needed and desired.

Referring specifically to cutting tooth 22A, this tooth includes six, right-angularly intersecting, straight-linear cutting edges 36, 38, 40, 42, 44, 46 which lie substantially at respective 45-degree angles α relative to rotor axis 14a (not specifically pictured in FIG. 3). These tooth-borne cutting edges collectively present and define in shredder 10 what is referred to herein as a rotor cutting profile, repetitive portions of which can clearly be seen in FIG. 3, View (a). In particular, these rotor-cutting-profile cutting edges form what is also referred to herein as a crenellation-like pattern that defines one side of shredding interface 12.

Cutting edges 36, 38 in tooth 22A outline a small, clearly evident, triangular tooth projection. As can be seen by comparing Views (a) and (b) in FIG. 3, cutting edge 40 and a portion of intersecting cutting edge 38 are substantially aligned (in cross section) with the inclined walls of one of the previously mentioned, circumferential, rotor-body channels, or grooves, such as groove 48 which, in View (b), is pictured in the fragmentarily illustrated body of rotor 14. Cutting edges 38, 40, 42 bound what is referred to herein as a crenellation-like, elongate, cutting-edge tooth channel 49, in which channel edges 38, 42 uniquely, directly face and substantially parallel one another. Cutting edges 42, 44, 46 in tooth 22A define what is referred to as an elongate, cutting-edge tooth finger. All other cutting teeth herein possess these same kinds of structural features.

Notably, and importantly, the configuration just described and illustrated for the cutting teeth results in the cutting edges therein which correspond to cutting edge 42 in tooth 22A each facing the body of the rotor rather than the bed-knife. These cutting edges, therefore, as represented by cutting edge 42, are referred to herein as being reverse-facing cutting edges in the cutting teeth. In a conventional shredder, cutting edges in rotor-carried cutting teeth typically face away from, rather than toward, the associated rotor body.

Continuing with a focus on FIG. 3, and in relation to the just described rotor (tooth) cutting profile, unitary bed-knife 16 is formed with a distributed, complementarily matching crenellation-like cutting edge pattern of linear, right-angularly intersecting cutting edges, such as those edges shown at shown at 50, 52, 54, 56, 58, 60. This distribution is referred to herein as a bed-knife cutting profile which defines the other side of shredding interface 12.

As can be seen, this bed-knife cutting profile is designed so that it matches closely with the rotor-tooth cutting profile, the former profile being in place as an entire profile, or a whole, all of the time because of the unitary structure of the bed-knife, and the latter existing in stages over a span of time as successively different cutting teeth that make up the rotor-tooth cutting profile sweep past the bed-knife during rotation of rotor 14.

Cutting edges 50, 52, 54, and their corresponding edge structures, in the bed-knife define elongate cutting-edge projections, or finger portions, 62 which specifically mesh complementarily with the previously described tooth channels, such as tooth channel 49. The outer angular tips, so-to-speak, of these bed-knife finger portions extend into the rotor circumferential channels, such as channel 48, whereby the bed-knife cutting-edge portions adjacent these tips lie in very close proximity to the channel-48 inclined surfaces in the rotor in the region of the mentioned shredding-swath overlaps.

Cutting edges 54, 56, 58 in the bed-knife define crenellation channels, such as channel 64, which are designed meshingly to receive the previously described elongate cutting tooth fingers formed in the cutting teeth. In channel 64, edges 54, 58 uniquely, directly face and substantially parallel one another.

Especially to be noted with respect to the cutting-edge structure that has just been described regarding bed-knife 16, is that those cutting edges which correspond to cutting edge 54 are seen effectively to face the main body of the bed-knife, rather than the body of the rotor. Accordingly, these specific cutting edges in the bed-knife are referred to herein as reverse-facing cutting edges.

Cutting edges 54 and previously described cutting edges 42 are collectively referred to herein as reverse-facing, mutually facing, linear and substantially parallel cutting edges.

Finally with respect to FIG. 3, and looking specifically at View (c) therein, shown by a dashed line 66 in this view is an isolated fragmentary outline of the elongate, angular, crenellation-form, straight-linear, line-pattern shredding interface 12 of the present invention.

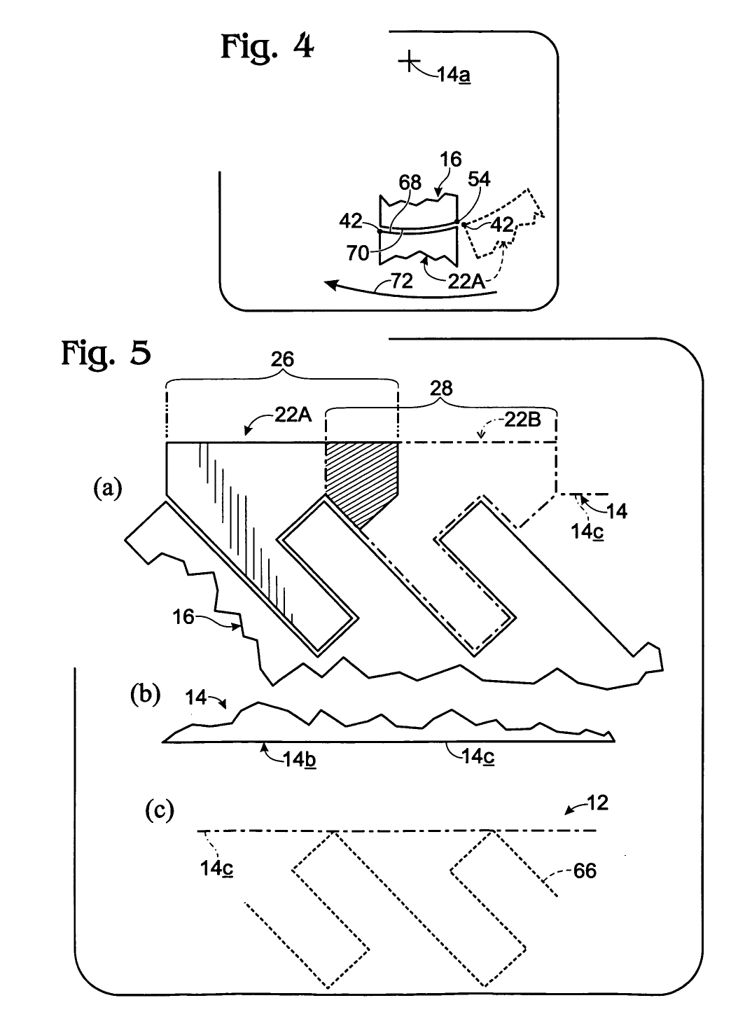

Turning attention now to FIG. 4 in the drawings, this is a fragmentary schematic view which is taken, in large part, generally along the line 4-4 in FIG. 3, View (a). This view, which includes an illustration of the relative location of rotor axis 14a, is intended further to illustrate the dispositions and actions of what were just described as being the reverse-facing, mutually facing cutting edges, such as edges 42, 54, existing in the cutting teeth and in the bed-knife, respectively.

In FIG. 4 the previously described tooth finger in illustrated tooth 22A is shown in two positions, including a dashed-line position which is disposed toward the right side of this figure, and a solid-line position wherein it is disposed fully meshed within above-described channel 64 in the bed-knife. The described reverse-facing, mutually facing edges 42, 54 are highlighted by darkened dots in this figure, with cutting edge 42 being shown in two different positions. What will be noticed, among other things, in FIG. 4 is that cutting edges 42, 54 in tooth 22A and in bed-knife 16, respectively, actually define linear edges of curved cutting surfaces 68, 70, respectively, that are formed in the illustrated tooth and bed-knife, respectively. These curved surfaces, because of the angular inclinations of the cutting-edge structures in the cutting teeth and in the bed-knife, take the form of cones having surfaces of revolution which are centered on rotor axis 14a, and they accommodate close-proximity, motion-pass-through, shredding-meshing between the rotor-carried cutting teeth and the bed-knife. Cutting-tooth motion is indicated by curved arrow 72 in FIG. 4.

It should also be noted that, uniquely with respect to bed-knife 16, not only is just-mentioned cutting surface 70 a surface of revolution centered on axis 14a, this is also the case for the other cutting surfaces present in the bed-knife, such other cutting surfaces being associated, at edges therein, with the cutting edges represented by specifically illustrated cutting edges 50, 52, 56, 58, 60.

Finally, now, addressing FIG. 5 in the drawings, the three Views (a), (b), (c) which are shown in this figure are, as mentioned earlier, very much like the three (a), (b), (c) views pictured in FIG. 3, with the exception, as can be seen especially in View (b), that the outer surface of rotor 14 does not include the earlier described V-grooves, or channels, but rather, is essentially purely cylindrical in outside configuration. With this difference in existence, and as also can be clearly seen in FIG. 5, the cutting edge structures in the cutting teeth and in bed-knife 16 differ dimensionally somewhat from those same features as pictured in the embodiment of the invention illustrated in FIG. 3, with the outer extremities or tips of the finger portions in the bed-knife still being positioned extremely close to the outer surface of the rotor body, but not within any grooves, or channels, formed in that body. Because of the close similarities of the structures pictured in both FIGS. 3 and 5, like reference numerals and characters are employed in each of these two figures for corresponding structural elements.

With regard to both embodiments of the invention illustrated and described herein, the earlier-mentioned, important behavioral concept embodied in the interface of the invention involving so-called reverse-facing, cutting-edge, pass-by-interlocking is characterized by the always present, interface-meshed condition wherein a tooth edge 42, and the like, is engaged with a bed-knife edge 54, and the like, during pass-by, or pass-through, meshing of a tooth finger or a finger portion in the bed-knife with a crenellation channel formed in the bed-knife or in a cutting tooth, respectively. As was mentioned earlier, this condition prevents a particular kind of parting, or separating, from occurring between the rotor and the bed-knife, as, for example, a separation or a parting taking place along a line, like that arrow-headed line pictured at 74 in FIG. 1, lying both in the plane of this figure, as well as in a plane normal to the plane in the figure. In fact, throughout an angular range of such second-mentioned, differently inclined planes, as is generally suggested by the small, curved, double-headed arrow 76 in FIG. 1, separation/parting as described is prevented.

While such a separation, per se, is not particularly an issue directly involving shredding behavior, the presence of the condition of intermeshing between successive cutting teeth and the bed-knife which creates the anti-parting/anti-separation condition just explained is responsible, in important part, for the establishment of characteristics in shredding interface 12 which result in essentially 100% proper shredding taking place during operation of shredder 10.

Accordingly, a preferred and best mode embodiment, and one variation thereof, of the present invention have been illustrated and described herein, and the features of the shredding interface therein clearly illustrated and discussed, which features distinguish the important, significantly improved shredding behavior of the invention from those behaviors of prior art material shredders. While such a disclosure of the invention has thus been presented herein, I appreciate that variations and modifications not directly discussed or shown in the present disclosure may be made without departing from the spirit of the invention, and I intend that the following claims to invention will be construed to cover all such variations and modifications which may come to the minds of those generally skilled in the relevant art.

I claim:

1. A material shredder comprising
an elongate rotor including distributed, outwardly projecting cutting teeth having cutting edges collectively defining a rotor cutting profile, and
an elongate bed-knife disposed operatively adjacent said rotor and possessing distributed cutting edges collectively defining a bed-knife cutting profile which meshes complementarily with said rotor cutting profile with rotation of the rotor,
said profiles collectively defining an elongate shredding interface wherein there are certain reverse-facing, mutually facing, respective cutting edges in the teeth and bed-knife that face, respectively, toward and away from said rotor.

2. The shredder of claim 1, wherein said rotor has an axis of rotation, and said mutually facing cutting edges are linear and substantially parallel to one another, and lie each effectively at substantially a 45° angle relative to said axis.

3. The shredder of claim 1, wherein said distributed teeth include pairs of axially next-adjacent teeth which travel in laterally overlapping shredding swaths relative to said bed-knife during rotation of said rotor.

4. The shredder of claim 3, wherein said rotor includes a generally cylindrical body having an outside surface, and in each region of next-adjacent-tooth lateral overlap, said bed-knife includes a cutting edge which extends essentially to said outside surface.

5. The shredder of claim 1, wherein each tooth includes a crenellation-like, cutting-edge channel, and for each said channel in each tooth, said bed-knife includes an associated, cutting-edge projection which, with rotation of said rotor, passes relatively, complementarily, and meshingly through the associated channel.

6. The shredder of claim 5, wherein said mutually facing, respective cutting edges are associated with one another in the locations of said channels and projections.

7. The shredder of claim 1, wherein said rotor is rotatable about a rotor axis, and certain cutting edges in said teeth define linear edges of curved, teeth cutting surfaces, each of which surfaces takes the form of a portion of the surface of a cone having an axis of revolution which coincides with said rotor axis.

8. A material shredder comprising
an elongate rotor having a generally cylindrical outer-surfaced body which is rotatable about a rotor axis,
a distribution of plural, common-configuration cutting teeth joined to said body and having cutting edges projecting generally radially outwardly from immediately adjacent said body's outer surface to define, with rotation of said rotor, one side of an elongate, continuous, two-sided shredding interface which generally parallels said axis, and
an elongate-bed knife disposed operatively adjacent and along said rotor in a manner substantially paralleling said axis and defining the other side of said shredding interface, said bed-knife including distributed cutting-edge portions which extend essentially to the outer surface of said body.

9. The shredder of claim 8, wherein the outer surface of said body, in relation to each of said teeth, is formed, relative to said axis, with a radially inset, circumferential channel, and said bed-knife includes, for each said channel, a finger portion which fits complementarily within said channel.

10. The shredder of claim 8, wherein said teeth, as distributed, include pairs of axially next-adjacent teeth which travel in laterally overlapping shredding swaths relative to said bed-knife during rotation of said rotor, the outer surface of said body, in relation to each of said teeth, is formed, relative to said axis, with a radially inset, circumferential channel which lies in such a swath, and for each said channel, said bed-knife includes a cutting edge portion which extends complementarily into said channel.

11. A material shredder comprising
an elongate rotor including distributed, outwardly projecting cutting teeth having cutting edges collectively defining a rotor cutting profile, and
an elongate bed-knife disposed operatively adjacent said rotor and possessing distributed cutting edges collectively defining a bed-knife cutting profile which meshes complementarily with said rotor cutting profile with rotation of the rotor,
said profiles collectively defining an elongate shredding interface which is characterized, at least in part, by reverse-facing, pass-by-interlocking, rotor-teeth/bed-knife cutting edges.

12. A material shredder comprising
an elongate rotor including distributed, outwardly projecting cutting teeth having cutting edges collectively defining a rotor cutting profile, and each including a pair of such edges which substantially directly face one another, and
an elongate bed-knife disposed operatively adjacent said rotor and possessing distributed cutting edges collectively defining a bed-knife cutting profile which meshes complementarily with said rotor cutting profile with rotation of the rotor, said cutting edges in said bed-knife also including a pair of edges which substantially directly face one another,
said profiles collectively defining an elongate shredding interface which is characterized, at least in part, by reverse-facing, pass-by-interlocking, rotor-teeth/bed-knife cutting edges that include at least one each of the substantially directly-facing edges in said teeth and bed-knife.

13. The shredder of claim 12, wherein said substantially directly-facing edges in each of said teeth and said bed-knife substantially parallel one another.

14. A material shredder comprising
an elongate rotor having a rotor axis, and including distributed, outwardly projecting cutting teeth having cutting-edges collectively defining a rotor cutting profile, and
an elongate bed-knife disposed operatively adjacent said rotor, and possessing distributed cutting edges and cutting surfaces collectively defining a bed-knife cutting profile which meshes complementarily with said rotor cutting profile with rotation of the rotor, said cutting surfaces in said bed-knife taking the form of surfaces of revolution substantially centered on said rotor axis.
